(19) United States
(12) Patent Application Publication
(10) Pub. No.: US 2016/0210245 A1
(43) Pub. Date: Jul. 21, 2016

(54) CIRCUIT FOR ACCESSING MEMORY AND ASSOCIATED ACCESSING METHOD

(71) Applicant: MStar Semiconductor, Inc., Hsinchu Hsien (TW)

(72) Inventors: Yu-Hsiang Tseng, Hsinchu Hsien (TW); Cheng-Yu Hsieh, Hsinchu Hsien (TW)

(21) Appl. No.: 14/996,304

(22) Filed: Jan. 15, 2016

(30) Foreign Application Priority Data
Jan. 21, 2015 (TW) 104102007

(51) Int. Cl. G06F 12/12; G06F 12/10

(52) U.S. Cl. CPC G06F 12/128; G06F 12/1009; G06F 12/1045; G06F 2212/69; G06F 2212/656

(57) ABSTRACT

A circuit for accessing a memory is provided. The memory includes a scatter table storage region and a plurality of storage regions. The scatter table storage region stores a plurality of entries that record starting addresses and sizes of the data storage regions, respectively. The circuit includes an accessing circuit and a cache. The cache stores an entry read from the scatter table storage region. When the accessing circuit needs to access data from the data storage regions, the accessing circuit issues a read request to the cache to read the entry from the cache, determines whether the data is stored in the storage region recorded by the entry according to contents of the entry, and further accordingly determines whether to access the memory to obtain the data according to the contents of the entry.

This application claims the benefit of Taiwan application Serial No. 104102007, filed Jan. 21, 2015, the subject matter of which is incorporated herein by reference.

### BACKGROUND OF THE INVENTION

1. Field of the Invention

The invention relates in general to memory access, and more particularly to a circuit for accessing a scatter memory and an associated accessing method.

2. Description of the Related Art

In a conventional distributed memory, a scatter table is stored. The scatter table records multiple entries, each recording the starting address and size of one data storage region in the memory. The sizes of multiple data storage regions corresponding to multiple entries recorded in the scatter table may not be consistent, and may not be continuous addresses. During an access process of the memory, as the sizes of the data storage regions may not be consistent and the addresses may not be continuous, in order to access the data stored previously stored in other data storage regions in the memory, the entries recorded in the scatter table need to be sequentially read one after another to determine in which data storage region the required data is stored. Such process lengthens the access time of the memory.

### SUMMARY OF THE INVENTION

It is an object of the present invention to provide a circuit for accessing a memory and an associated accessing method that are capable of reducing the access time of the memory, thereby solving an issue of the prior art.

A circuit for accessing a memory is provided according to an embodiment of the present invention. The memory includes a scatter table storage region and a plurality of data storage regions. The scatter table storage region stores a plurality of entries that record starting addresses and sizes of the data storage regions, respectively. The circuit includes: an accessing circuit, coupled to the memory, accessing the memory; and a cache, coupled to the accessing circuit and the memory, reading the scatter table storage region, and to store one of the entries read from the scatter table storage region. When the accessing circuit needs to access a set of data stored in the data storage regions, the accessing circuit issues a read request to the cache to read the entry from the cache, determines whether the data is stored in the data storage region recorded by the entry according to the size of the data storage region recorded by the entry, and determines whether to access the memory to obtain the data according to the starting address of the data storage region recorded by the entry.

A method for accessing a memory is provided according to another embodiment of the present invention. The memory includes a scatter table storage region and a plurality of data storage regions. The scatter table storage region stores a plurality of entries that record starting addresses and sizes of the data storage regions, respectively. The method includes: reading the scatter table storage region by a cache, and storing one of the entries read from the scatter table storage region by the cache; and when a set of data stored in the data storage regions needs to be accessed, issuing a read request to the cache to read the entry from the cache, determining whether the data is stored in the data storage region recorded by the entry according to the size of the data storage region recorded by the entry, and accordingly determining whether to access the memory to obtain the data according to the starting address of the data storage region recorded by the entry.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a schematic diagram of a memory;

FIG. 2 is a schematic diagram of a circuit for accessing a memory according to an embodiment of the present invention; and

FIG. 3 is a flowchart of a method for accessing a memory according to an embodiment of the present invention.

### DETAILED DESCRIPTION OF THE INVENTION

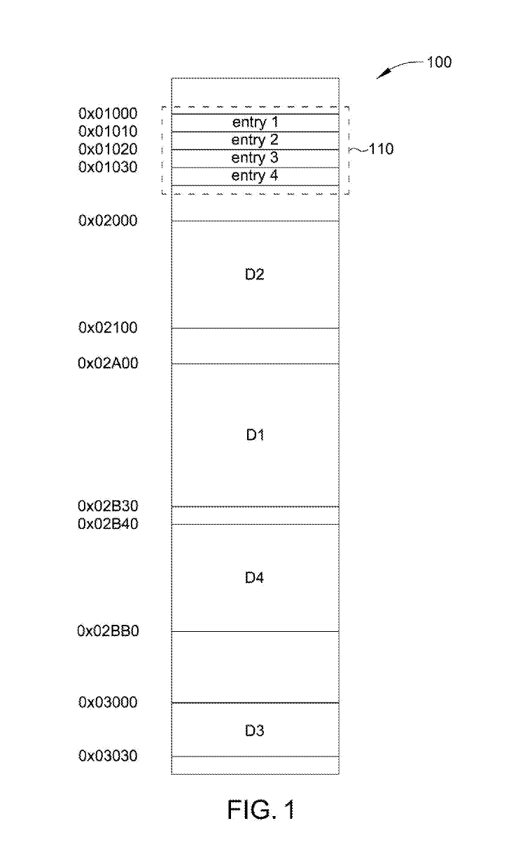

FIG. 1 shows a schematic diagram of a memory 100. As shown in FIG. 1, the memory 100 is a distributed memory, and includes a scatter table 110 and multiple data storage regions D1 to D4. The scatter table 110 includes multiple entries, each storing a starting address and a size of a corresponding data storage region. In the example shown in FIG. 1, the entry 1 records that the data storage region D1 has a starting address of 0x02A00 and a size of 304 bytes, the entry 2 records that the data storage region D2 has a starting address of 0x02000 and a size of 256 bytes, the entry 3 records that the data storage region D3 has a starting address of 0x03000 and a size of 48 bytes, and the entry 4 records that the data storage region D4 has a starting address of 0x02B40 and a size of 112 bytes. It should be noted that, the number of entries, and the number, starting addresses and sizes of data storage regions are for illustration purposes for better explaining the present invention, and are not to be construed as limitations to the present invention.

In an access operation of the memory 100, if a decoding circuit needs to access data from the memory 100, the decoding circuit is required to first read one entry in the scatter table 110, and then accesses the data from the memory 100 according to the starting address of the data storage region recorded by the entry. For example, the decoding circuit needs to first read the item 1 in the scatter table 110 to learn that the starting address of the data storage region D1 is 0x02A00, and then reads the data from the data storage region D1 in the memory 100 or write the data to the data storage region D1 according to this starting address 0x02A00.

However, when the decoding circuit performs certain decoding operations, e.g., a decompression operation based on an Lempel-Ziv-Markov chain algorithm (LZMA), a zlib algorithm, or an LZ77 algorithm, previously decoded data is needed as a reference for decoding a next set of data. For example, it is assumed that the decoding circuit decodes a data string to continuously generate decoded data, and sequentially stores the generated decoded data to the data storage regions D1, D2, D3 and D4 in the memory 100. It is also assumed that the decoded data is to be currently written to the 10^{th} byte of the data storage region D4. At this point, if the current decompression operation needs to use 20 bytes following the previous 150^{th} byte of data (i.e., including the decoded data from the previous 150^{th} byte to the previous 131^{st} byte), in the prior art, the required decoded data is obviously not in the data storage region as the data storage region D4 is only written up to the 10^{th} byte. Thus, the decoding circuit first reads the entry 3 and determines whether the required data is stored in the data storage region D3. If the required data is in the data storage region D3, the decoding circuit accesses the required data from the data storage region D3 and uses the accessed required data as the reference for the current decoding operation. However, if the required data is not stored in the data storage region D3, the decoding circuit next reads the entry 2 to determine whether the required data is in the data storage region D2. The above steps are iterated until the required data is accessed.

As previously described, in the prior art, it is essential to read the entries in the scatter table 110 one after another until the required data is found, hence leading to following issues. First of all, since the scatter table 110 and the data storage regions D1 to D4 in the memory 100 are located at different addresses, a read burst of the memory may be interrupted. Secondly, due to different sizes of the data storage regions D1 to D4, assuming that the decoding circuit needs to use 20 bytes of decoded data following the previous 150^{th} byte, the decoding circuit has no way of knowing which entry corresponds to the data storage region where “the 20 bytes of decoded data following the previous 150^{th} byte” is located. Thus, the decoding circuit needs to read and determine the entries in the scatter table 110 one after another—such process is extremely time consuming.

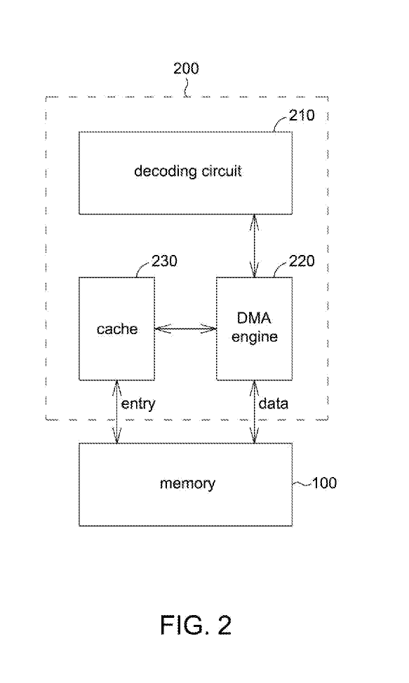

To solve the above issues, the present invention provides a circuit for accessing a memory. FIG. 2 shows a schematic diagram of a circuit 200 for accessing the memory 100 according to an embodiment of the present invention. As shown in FIG. 2, the circuit 200 includes a decoding circuit 210, an accessing circuit, and a cache 230. In this embodiment, the accessing circuit is a direct memory access (DMA) engine 220. In the embodiment, the decoding circuit 210 includes a decompression circuit, e.g., a decompression circuit that performs decompression based on an LZMA, zlib or LZ77 algorithm. The decoding circuit decompresses a data string to generate decompressed data, and stores the generated data string into the memory 100 via the DMA engine 220. In the embodiment, the memory 100 is a dynamic random access memory (DRAM). However, in other embodiments, the memory 100 may be implemented by a cache or a flash memory. Further, the cache 230 may be implemented by a static random access memory (SRAM).

In the embodiment in FIG. 2, the DMA engine 220 and the cache 230 are described as two different elements. However, one person skilled in the art can understand that, the cache 230 may also be integrated in the DMA engine 220. Given functional operations are the same as those in the embodiment, circuit blocks are not limited to the examples shown in the embodiment in FIG. 2.

Referring to FIG. 1 and FIG. 2, in the operations of the circuit 200, the decoding circuit 210 decodes a data string, and sends the generated decoded data to the DMA engine 220. The DMA 220 obtains the entry from the scatter table 110 in the memory 100 via the cache 230, and sequentially writes the decoded data into the data storage region D1 according to the starting address recorded by the entry 1. The DMA 220 then obtains the entry 2 from the scatter table 110 in the memory 100 via the cache 230, and sequentially writes the decoded data into the data storage region D2 according to the starting address recorded by the entry 2, and so forth. The cache 230 preserves the last few entries provided to the DMA engine 220. When the decoding circuit 210 needs the decoded data previously stored into the data storage regions D1 to D4 in a subsequent decoding operation, the DMA 220 first issues a request to the cache 230 to request for contents of the entries in the scatter table 110. At this point, the cache 230 first sends the temporarily stored entries in the cache 230 to the DMA engine 230 for the DMA 230 to determine whether the required data is stored in the data storage region corresponding to the entry. If so, the DMA engine 230 accesses the data from the memory 100 according to the starting address recorded by the entry. If the required data is not stored in the data storage region corresponding to the entry temporarily stored in the cache 230, the DMA engine 220 requests the cache 230 to read entries further ahead from the memory 100.

An example is given below for better describing details of the operations of the circuit 200. In the example below, it is assumed that the cache 230 is capable of temporarily storing two entries given that the currently read entry is not included. It should be noted that the above is not to be construed as a limitation to the present invention. Referring to FIG. 1 and FIG. 2, the decoding circuit 210 decodes a data string and generates decoded data. The decoded data is sent to the DMA engine 220 and is to be written into the memory 100. The DMA 220 first issues a write request to the cache 230, which reads the entry 1 from the scatter table 110 in the memory 100 and sends contents recorded by the entry 1 (i.e., the data storage region D1 has a starting address of 0x02A00 and a size of 304 bytes) to the DMA 220. The DMA 220 then sequentially writes the decoded data into the data storage region D1 of the memory 100, starting from the starting address 0x02A00. When the 304-byte decoded data is completely written into the data storage region D1, the DMA 220 issues a next write request to the cache 230, which reads the entry 2 from the scatter table 110 in the memory 100 (the contents of the entry 1 are temporarily stored in the cache 230 at this point), and sends contents recorded by the entry 2 (i.e., the data storage region D2 has a starting address of 0x02000 and a size of 256 bytes) to the DMA 220. The DMA 220 then sequentially writes the decoded data into the data storage region D2 of the memory 100, starting from the starting address 0x02000. The above steps are repeated. More specifically, when the data storage region D2 is fully written with decoded data, the decoded data is written to the data storage region D3 and the data storage region D4 of the memory 100 via the DMA engine 220 and the cache 230.

It is assumed that the current decoded data is stored to 10 bytes of the data storage region D4, and the decoding circuit 210 needs 20 bytes of data following the previous 100^{th} byte of data (i.e., including decoded data from the previous 100^{th} byte to the previous 81^{st} byte) to decode a next set of data. Thus, the decoding circuit 210 issues a command to the DMA 220 to instruct the DMA 220 to return to the address of the 100^{th} byte previous to the current position and to fetch 20 bytes of data. At this point, the DMA engine 220 first determines whether the data storage region D4 currently being written with data contains the decoded data that the decoding circuit 210 needs. In the embodiment, as the data storage region D4 contains only 10 bytes of decoded data, the data storage region D4 does not include the decoded data that the decoding circuit 210 needs. Next, the DMA circuit 220 issues a read request to the cache 230 to request for contents of the previous entry. At this point, the cache 230 is temporarily stored with the entry 2 and the entry 3, and so the cache 230 first directly sends the contents of the entry 3 (i.e., the starting address and size of the data storage region D3) to the DMA engine 220. According to the received size information associated with the data storage region D3, the DMA engine 220 determines whether the data storage region D3 is stored with the decoded data that the decoding circuit 210 needs. In the embodiment, since the data storage region D3 contains only 48 bytes of decoded data, the data storage region D3 does not contain the decoded data that the decoding circuit 210 needs, either. The DMA engine 220 then issues a read request to the cache 230 to request for contents of another previous entry. At this point, the cache 230 first directly sends the contents of the entry 2 (i.e., the starting address and size of the data storage region D2) to the DMA 220. According to the received size information associated with the data storage region D2, the DMA engine 220 determines whether the data storage region D2 is stored with the decoded data that the decoding circuit 210 needs. In this embodiment, since the data storage region D2 contains 256 bytes of decoded data, the decoded data that the decoding circuit 210 needs is in the data storage region D2. At this point, according to the starting address of the data storage region D2 and the data amount of decoded data currently written in the data storage regions 2 to 4 (in this embodiment, the data amount is 10+48+256=314 bytes), the DMA 220 calculates the address of the decoded data that the decoding circuit 210 needs. Thus, the DMA engine 220 fetches the decoded data from the data storage region D2 of the memory 100, and returns the decoded data to the decoding circuit 210.

In another situation, it is assumed that the current decoded data is 10 bytes in the data storage region D4, and the decoding circuit 210 needs to use 10 bytes of decoded data following the previous 500^{th} byte (i.e., including the decoded data from the previous 500^{th} byte to the previous 491^{st} byte) to decode a next set of data. Similar to the step at the beginning of the previous paragraph, the decoding circuit 210 issues a command to the DMA 220 to instruct the DMA 220 to return to the address that is 500^{th} bytes previous to the current position, and to fetch 10 bytes of data. At this point, as the cache 230 is temporarily stored with the entry 2 and the entry 3, the DMA engine 220 learns that the required decoded data is not in the data storage region D2 or the data storage region D3 according to the contents of the entry 2 and the entry 3 read from the cache 230. Thus, the DMA engine 220 again issues a read request to the cache 230 to request for contents of another previous entry. As the cache 230 does not contain contents of any temporarily stored entry, the cache 230 reads the contents of the entry 1 (i.e., the starting address and size of the data storage region D1) from the scatter table 110 in the memory 100, and sends the contents of the entry 1 to the DMA engine 220. According to the received size information associated with the data storage region D1, the DMA engine 220 determines whether the data storage region D1 is stored with the decoded data that the decoding circuit 210 needs. In this embodiment, since the data storage region D1 contains 304 bytes of decoded data, the decoded data that the decoding circuit 210 needs is in the data storage region D1. At this point, according to the starting address of the data storage region D1 and the data amount of decoded data currently written in the data storage regions D1 to D4 (in this embodiment, the data amount is 10+48+256+304=618 bytes), the DMA 220 determines the address of the decoded data that the decoding circuit 210 needs. Thus, the DMA engine 220 fetches the decoded data from the data storage region D1 of the memory 100, and returns the decoded data to the decoding circuit 210.

As previous described, when a read command of the decoding circuit 210 is received and the DMA engine 220 requests for contents of an entry from the cache 230, the cache 230 first sends the contents of the entry temporarily stored therein to the DMA engine 220 instead of reading the scatter table 110 in the memory 100 each time. Only when the cache 230 does not contain the contents of the required entry, the contents of the required entry are read from scatter table 110. Thus, not only the access time of the memory 100 is reduced, but also production costs are kept minimal.

In the above example, the DMA 220 only requests for contents of one entry from the cache 230 each time. That is, the cache 230 returns the contents of the entry 3 when the DMA engine 220 issues one read request, and only returns the contents of the entry 2 when the DMA engine 220 issues a next read request. However, in one embodiment of the present invention, if the cache 230 is implemented by a flip-flop, the cache 230 may return the contents of the entry 2 and the entry 3 all in once to further reduce the access time.

It should be noted that, FIG. 1 is an example used to describe the operations of the circuit 200, and is not to be construed as a limitation to the present invention. For example, the entries temporarily stored in the cache 230 may be contents of N entries, where N is an appropriate positive integer. A mechanism for updating the temporarily stored data in the cache 230 may have different designs according to the algorithm applied. Alternatively, if the cache 230 does not contain any temporarily stored data, contents of two entries may be read from the scatter table 110 at a time. It should be noted that the above designs and variations are encompassed within the scope of the present invention.

In the above embodiments, as the sizes of the data storage regions D1 to D4 may be different, the DMA engine 220 is required to sequentially receive the contents of the entry 3, the entry 2 and the entry 1 to determine the location of the decoded data that the decoding circuit 210 needs. However, in another embodiment of the present invention, assuming that the sizes of the data storage regions are equal, e.g., 512 bytes, instead of having to sequentially receive the contents of the entry 3, the entry 2 and the entry 1, the DMA engine 220 is capable of estimating in which data storage region the required decoded data is located according to an algorithm of the DMA engine 220. Thus, the DMA engine 220 may directly request the cache 230 for the contents of the required entry. For example, it is assumed that the DMA engine 220 is currently writing data into the data storage region D4, and the decoding circuit 210 requests for 10 bytes of decoded data following the previous 1200^{th} byte. Accordingly, the DMA engine 220 can easily learn the decoded data is not stored in the data storage region D3 through simple calculations, and the data is possibly stored in the data storage region D2 or the data storage region D1. Thus, the DMA engine 220, directly skipping the entry 3, may directly issue a read request to the cache 230 to request for contents of the entry 2 to further reduce the access time.

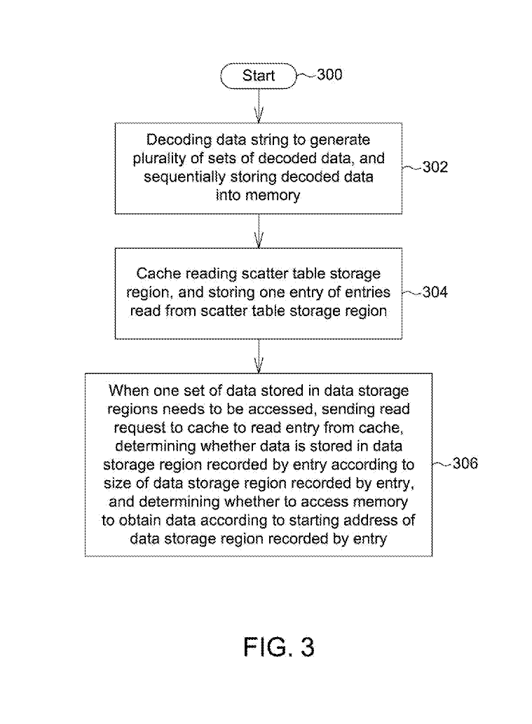

FIG. 3 shows a flowchart of a method for accessing a memory according to an embodiment of the present invention. Referring to FIGS. 1 to 3, the process of the method includes following steps.

In step 300, the process begins.

In step 302, a data string is decoded to generate a plurality of sets of decoded data, and the decoded data is stored into the memory.

In step 304, the scatter table storage region is read by a cache, and one of the entries read from the scatter table storage region is stored in the cache.

In step 306, when data stored in the data storage regions needs to be accessed, a read request is issued to the cache to read the entry from the cache. It is then determined whether the data is stored in the data storage region recorded by the entry according to a size of the data storage region recorded by the entry. Next, it is determined whether to access the memory to obtain the data according to a starting address of the data storage region recorded by the entry.

In conclusion, in the circuit for accessing a memory and the associated accessing method of the present invention, a cache is utilized to read contents of an entry from a scatter table in a memory. When the DMA engine needs to read the contents of the entry, the contents of the entry can be directly obtained from the cache instead of having to read the contents of the entry from the scatter table in the memory each time. Thus, the time needed for accessing the memory can be reduced, and a read burst of the memory is less likely interrupted.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A circuit for accessing a memory, the memory comprising a scatter table storage region and a plurality of data storage regions, the scatter table storage region storing a plurality of entries, the entries recording starting addresses and sizes of the data storage regions, respectively, the circuit comprising:
an accessing circuit, coupled to the memory, accessing the memory; and
a cache, coupled to the accessing circuit and the memory, reading the scatter table storage region, and storing one entry of the entries read from the scatter table storage region;
wherein, when the accessing circuit needs to access one set of data stored in the data storage regions, the accessing circuit issues a read request to the cache to read the entry from the cache, determines whether the data is stored in the data storage region recorded by the entry according to the size of the data storage region recorded by the entry, and determines whether to access the memory to obtain the data according to the starting address of the data storage region recorded by the entry.

2. The circuit according to claim 1, wherein the cache stores another entry of the entries read from the scatter table storage region; when the accessing circuit determines not to access the memory to obtain the data according to the starting address of the data storage region recorded by the entry, the accessing circuit issues another read request to the cache to read the another entry from the cache.

3. The circuit according to claim 1, further comprising:
a decoding circuit, coupled to the accessing circuit, decoding a data string to sequentially generate a plurality of sets of decoded data, and to sequentially store the decoded data into the memory via the accessing circuit;
wherein, the data is a part of the decoded data that the decoding circuit needs for decoding the data string.

4. The circuit according to claim 3, wherein when the decoding circuit sequentially stores the decoded data into the memory via the accessing circuit, the accessing circuit sequentially issues a plurality of write requests to the cache, the cache reads the scatter table storage region according to the write requests and sequentially sends the M^{th} to the (M+L)^{th} entries read from the scatter table storage region to the accessing circuit, and the accessing circuit sequentially stores the decoded data to the M^{th} to the (M+L)^{th} data storage regions corresponding to the M^{th} to the (M+L)^{th} entries in the memory; the cache stores the last N entries to be sent to the accessing circuit, where M, L and N are positive integers, and N is smaller than L.

5. The circuit according to claim 4, wherein when the decoding circuit issues a command to the accessing circuit to request to access the data, the accessing circuit issues at least one read request to the cache, and the cache, starting from the (M+L−1)^{th} entry, sequentially sends contents of the entries to the accessing circuit until the accessing circuit determines in which the data storage region the data is located.

6. The circuit according to claim 5, wherein when the cache has sent the contents of the (M+L−1)^{th} to the M^{th} entries to the accessing circuit and the accessing circuit has yet not determined in which the data storage region the data is located, the cache reads the (M−1)^{th} entry from the scatter table storage region and sends the (M−1)^{th} entry to the accessing circuit.

7. The circuit according to claim 3, wherein the decoding circuit is one of an LZMA decoding circuit, a zlib decoding circuit, and an LZ77 decoding circuit.

8. A method for accessing a memory, the memory comprising a scatter table storage region and a plurality of data storage regions, the scatter table storage region storing a plurality of entries, the entries recording starting addresses and sizes of the data storage regions, respectively, the method comprising:
reading the scatter table storage region by a cache, and storing one entry of the entries read from the scatter table storage region by the cache; and
when a data stored needs to be accessed from the data storage regions, issuing a read request to the cache to read the entry from the cache, determining whether the data is stored in the data storage region recorded by the entry according to the size of the data storage region recorded by the entry, and determining whether to access the memory to obtain the data according to the starting address of the data storage region recorded by the entry.

9. The method according to claim 8, further comprising:
storing another entry of the entries read from the scatter table storage region by the cache; and
when it is determined not to access the memory to obtain the data according to the starting address of the data storage region recorded by the entry, issuing another read request to the cache to read the another entry from the cache.

10. The method according to claim 8, further comprising:
decoding a data string to sequentially generate a plurality of sets of decoded data, and sequentially storing the decoded data into the memory;
wherein, the data is a part of the decoded data needed for decoding the data string.

11. The method according to claim 10, wherein the step of sequentially storing the decoded data into the memory comprises:
sequentially issuing a plurality of write requests to the cache; and
the cache reading the scatter table storage region according to the write requests and sequentially sending the M^{th} to the (M+L)^{th} entries read from the scatter table storage region to an accessing circuit, and the accessing circuit sequentially storing the decoded data to the M^{th} to the (M+L)^{th} data storage regions corresponding to the M^{th} to the (M+L)^{th} entries in the memory; wherein the cache stores the last N entries to be sent to the accessing circuit, where M, L and N are positive integers, and N is smaller than L.

12. The method according to claim 11, wherein the entry is the (M+L−1)^{th} entry, and the step of accessing the data further comprises:
starting from the (M+L−1)^{th} entry, the cache sequentially sending contents of the entries to the accessing circuit until the accessing circuit determines in which the data storage region the data is located.

13. The method according to claim 12, wherein when the cache has sent the contents of the (M+L−1)^{th} to the M^{th} entries to the accessing circuit and the accessing circuit has not yet determined in which the data storage region the data is located, the cache reads the (M−1)^{th} entry from the scatter table storage region and sends the (M−1)^{th} entry to the accessing circuit.

14. The method according to claim 8, being applied to one of an LZMA decoding circuit, a zlib decoding circuit, and an LZ77 decoding circuit.
